(19) United States
(12) Patent Application Publication
(10) Pub. No.: US 2026/0222410 A1
(43) Pub. Date: Jul. 30, 2026

(54) A METHOD, SERVER AND COMPUTER SOFTWARE FOR PROVISIONING AN ENCRYPTED DOMAIN NAME SYSTEM

(71) Applicants: Vodafone Group Services Limited, Newbury, Berkshire (GB); Vodafone Servizi e Tecnologie S.r.L., Milan (IT)

(72) Inventors: Gianpaolo Angelo SCALONE, London (GB); Federico Andrea VELATI, London (GB)

(21) Appl. No.: 19/151,727

(22) PCT Filed: Jan. 24, 2024
(86) PCT No.: PCT/EP2024/051618

§ 371 Date: Jul. 29, 2025

(30) Foreign Application Priority Data
Feb. 1, 2023 (IT) 102023000001644

(51) Int. Cl. H04L 9/40; H04L 61/4511

(52) U.S. Cl. CPC H04L 63/102; H04L 61/4511; H04L 63/0428; H04L 63/0823

(57) ABSTRACT

A method of provisioning an encrypted Domain Name System, DNS, is provided. The method comprises: receiving, from a user device, a message requesting an address of a secure DNS server, wherein the message comprises a client address; determining, based on the client address, an address of a secure DNS server; and sending, to the user device, a message comprising the address of the secure DNS server.

### FIELD OF THE INVENTION

The present application relates to a Domain Name System (DNS). In particular, the present invention provides improved methods that facilitate delivery of network-based DNS features alongside encrypted DNS traffic.

### BACKGROUND

A Domain Name System (DNS) is used to translate domain names (e.g. human-readable domain names, such as “www.vodafone.com”) into IP addresses (e.g. 18.158.19.118). As such, a DNS server operates in the manner of an address book or directory for Internet addresses, to link website domain names with IP addresses that may be used to route IP traffic.

For a considerable time, DNS messages have been exchanged between client and server non-encrypted (“in clear text”). Since their inception around 1985, Domain Name Systems have not changed appreciably. However, there are recent plans to update DNS by adding an encryption layer and discovery protocols to it. One problem arising as a result of new encrypted protocols is that the existing service infrastructure is altered by changing the topology of the network and the entities involved.

Legacy DNS is provisioned by network (can be optionally modified by the user using the OS settings), while main encrypted DNS protocols (such as DNS over HTTPS, DoH, or DNS over QUIC, DoQ) are discovered using new protocols currently under standardization. The new protocols are more complex than plain DNS protocols and permit a level of customization that can help network operators to simplify the network topology and to implement new services on DNS.

Enhanced services, which may be offered with legacy DNS include:
protection against malicious domains;
parental controls;
implementation of court orders (e.g., blocking particular domains based on regional laws);
traffic analysis; and
traffic management.

New encrypted protocols are emerging, such as DoH (DNS over HTTPS), DoQ (DNS over Quick) and other variants. Encrypted protocols are desirable because they are more secure and can prevent malicious attacks, such as “man-in-the-middle” attacks. With encrypted DNS protocols, several issues arise, which include:
It is not easy as before to implement services;
DNS traffic cannot be analysed on-the-fly (while messages are in transit);
The network topology is more complex; and
Customer premises equipment (CPE, such as a user's home router) are not automatically able to decrypt the DNS traffic and so cannot be used for encrypted DNS.

The present invention aims to address the problems described above.

### SUMMARY

A method of provisioning an encrypted Domain Name System, DNS, is provided. The method comprising:
receiving, from a user device, a message requesting an address (IP address and domain) of a secure DNS server, wherein the message comprises a client address (IP address of the user device or home router);
determining, based on the client address, an address of a secure DNS server;
sending, to the user device, a message comprising the address of the secure DNS server.

Encrypted DNS is complex and can be used to enhance functionality and improve security. However, implementing encrypted DNS also gives rise to some problems. For example, to implement services, it is necessary for the DNS to be capable of identifying the user (e.g. using the IP address or a combination of the IP address and MAC address). However, in order to implement this, there are requirements placed on the network topology, such as:
the DNS has to be deployed at the edge of the network, before any network address translation; and
supporting elements also have to be at the edge of the network.

In some examples, the requirement for the plain DNS server or secure DNS server to be able to identify the user is referred to as “customer awareness”. In order to be “customer aware”, the plain DNS server or secure DNS server may identify the user device using the source IP address allocated to the device (and optionally the MAC address). Additionally or alternatively, the plain DNS server or secure DNS server may identify the user of the device (e.g., based on IP addresses associated with the user or allocated to the user by the network).

These requirements are incompatible with existing network topologies. For a variety of reasons, it is preferable for the secure DNS servers and supporting servers to be deployed centrally within the operator core network, rather than at the edge. One such reason is that centralised locations benefit from improved resource allocation, virtualization facilities, management capabilities and server interfacing. Encrypted DNS requires more resources than plain text DNS. Therefore, availability of these features is more important for encrypted DNS than for plain text DNS. Moreover, since deploying centrally typically requires fewer server locations than deploying at the network edge, server redundancy may be implemented more easily (e.g. to implement N+1 redundancy in 3 central locations requires 3 additional servers, whereas to implement in 10 edge locations requires 10 additional servers). Centralizing the servers also enables flexibility of resource allocation to assist with phased rollout of services. Encrypted DNS may be introduced in the network on a small scale at first and capacity may be increased as users are switched over to using the secure service.

The proposed solution therefore provides encrypted DNS that could be deployed centrally, while also providing user recognition. This gives rise to many advantages, such as:
at the edge of the network, only a basic DNS server is needed (such as a small port53 DNS, integrated with Radius);
encrypted DNS with user awareness may be implemented at one or more central sites, rather than at the edge of the network;
supporting elements, such as session manager, can also be deployed centrally; and
it is possible to configure the CPE to manage the DNS traffic.

Where the user device is connected via a fixed line network, messages between the DNS server and the user device may be exchanged via a customer premises equipment, CPE. In this case, the encrypted DNS could be distributed. This may be advantageous, in case DoH does not permit resolution on the CPE (so EDNS0 may not be feasible).

As an alternative, user identification may be implemented on the user device using an application. However, this would require user activity to install the application. This alternative therefore reduces the value for network operators compared to the proposed solution, which is fully network-based.

The client address may be the address used by the DNS server to correctly route the response (e.g. the IP address to which the response is sent). This may be the address of the immediate client of the DNS server, rather than the ultimate client, which is the user device. Where the user device is connected via a mobile network, the immediate client and the ultimate client may be the same. In other words, the client address is the address of the user device. Where the user device is connected via a fixed line network, messages between the DNS server and the user device may be exchanged via a home router. In this case, the client address may be the address of the home router.

The client address may be a client identifier. In the case of a user device connected via a mobile network, the client address may be an MSISDN (Mobile Subscriber ISDN [Integrated Services Digital Network] Number). In the case of a user device connected via a fixed line, the client address may be the Fixed Line ID.

The address of the secure DNS server may comprise an IP address and/or domain name. The address of the secure DNS server may comprise a Uniform Resource Identifier (URI).

The client address may be an address of the user device. In other words, the address received by the DNS server may relate directly to the user device.

In some examples, the user device is a mobile device connected to the internet via a mobile data connection. In this case, the user device is connected directly to the operator network (without a home router). Therefore, the message received by the DNS server comprises an address of the user device. The DNS server can respond by sending a message back to this address. The DNS server can identify the user based on the client address, which may be an MSISDN. The network topology is more straightforward in this case, compared to a scenario in which the user device is connected to the internet via a home router and internet service provider (in which case, the client address is the address of the home router).

Determining an address of a secure DNS server may comprise retrieving user data associated with the user device from a data store, based on the address of the user device. The user data may comprise one or more of:
user service profile preferences (e.g. whether the user is subscribed to a personalised service that requires the secure DNS server to be aware of the user identity); and
user characteristics (e.g. age).

Determining an address of a secure DNS server may further comprise:
selecting a secure DNS server from a plurality of secure DNS servers, based on the user service profile preferences and/or user characteristics.

In other examples, the client is connected to the internet via a home router, which is connected to the internet via a fixed line data connection. In this case, the device is not connected directly to the operator network. The router may perform network address translation, NAT, to route messages to and from the client. Therefore, the network topology is more complicated in this case, compared to the case described above in which the client is a mobile device connected to the internet via a mobile data connection.

The message received from the user device may be received via a home router (customer premises equipment, CPE). The home router may be configured to perform network address translation, NAT. In this case, the client address may be an address of the home router.

The message received from the user device may further comprise a user device identifier (e.g., a label assigned to the device such as a hostname or a physical identifier such as MAC address). The determining may be further based on the user device identifier.

The CPE may be configured to provide the user device identifier with Extension Mechanisms for DNS (EDNS). Specifically, EDNS0 may be used. Advantageously, EDNS0 may be used to ensure the MAC address is forwarded by the CPE to the plain DNS server.

Determining an address of a secure DNS server may comprise retrieving user data associated with the user device from a data store, based on the address of the home router and the user device identifier, wherein the user data comprises one or more of:
user service profile preferences (e.g. whether the user is subscribed to a personalised service); and
user characteristics (e.g. age).

The method may further comprise:
sending a message to a certificate server to request that the certificate server generate a certificate and send the certificate to the home router.

Determining an address of a secure DNS server may further comprise:
selecting a secure DNS server from a plurality of secure DNS servers, based on the user service profile preferences and/or user characteristics. The plurality of secure DNS servers may comprise the home router.

The method may further comprise:
determining, based on the client address, one or more DNS parameters,
wherein the message sent to the user device further comprises the one or more DNS parameters.

The one or more DNS parameters may be Service Binding, SVCB, fields.

The one or more DNS parameters may comprise a user identifier, preferably an encrypted user identifier. The user identifier may be:
the address of the user device; or
a combination of the address of the home router and a user device identifier.

The message received from the user device may be an internet protocol, IP, message.

The message received from the user device may be received via IP port53.

The encrypted Domain Name System may be selected from:
DNS over HTTPS (Secure Hypertext Transfer Protocol), DoH; or
DNS over QUIC (Quick UDP [User Datagram Protocol] Internet Connections), DoQ.

A server (e.g., a DNS server) configured to perform a method described above is also provided.

Computer software comprising instructions that, when executed by a processor of a computer, cause the computer to perform a method described above is also provided.

### BRIEF DESCRIPTION OF THE DRAWINGS

FIG. 1 illustrates a standard discovery protocol for Encrypted DNS (DoH).

A first example of an enhanced discovery protocol for a user device connected via a mobile network is illustrated in FIG. 2A.

A flow diagram for the first enhanced discovery protocol for a user device connected via a mobile network is illustrated in FIG. 2B.

A second example of an enhanced discovery protocol for mobile networks is illustrated in FIG. 3A.

FIG. 3B illustrates a flow diagram for the second enhanced discovery protocol, for a user allocated to a first service profile.

FIG. 3C illustrates a flow diagram for the second enhanced discovery protocol, for a user allocated to a second service profile.

An example of an enhanced discovery protocol for fixed networks is illustrated in FIG. 4A.

FIG. 4B illustrates a flow diagram for a client having personal services connected to the internet via a fixed network.

### DETAILED DESCRIPTION

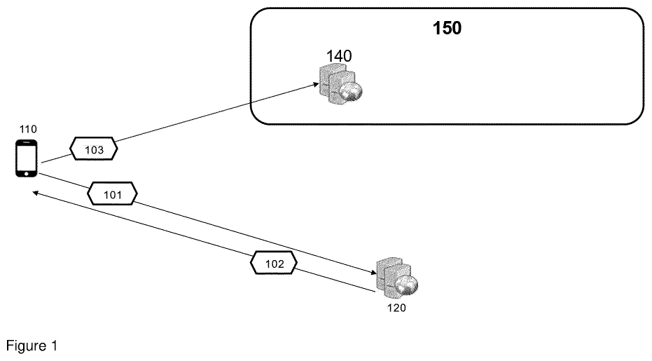

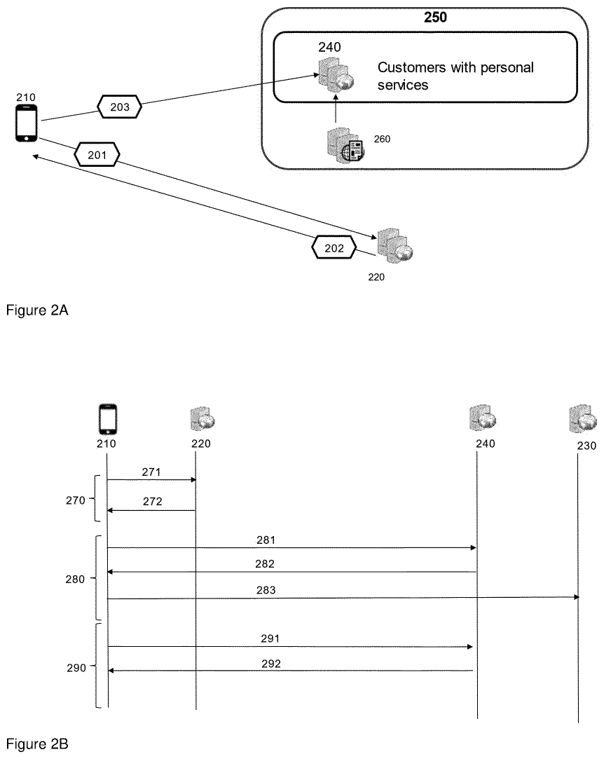

The present invention relates to network-based enrichments for encrypted DNS traffic. FIG. 1 illustrates the standard discovery protocol for Encrypted DNS (such as DoH or DoQ). This protocol may be referred to as Discovery of Designated Resolvers, DDR.

At step 101, a user device 110 sends a message to a plain DNS server 120. For example, the first query may be sent to a plain DNS server 120 at “doh.Vodafone.com”.

At step 102, the DNS server 120 replies to the user device 110 and provides an address (IP address) of a Secure DNS server 140 (such as a DoH server or DoQ server). The DNS server 120 may also provide service binding, SVCB, fields to the user device 110.

At step 103, the user device 110 sends a message to the secure DNS server 140, using the address supplied to the user device 110 by the plain DNS server 120. For example, the user device 110 may send a message to “HTTPS://doh.Vodafone.com/?dns”.

The secure DNS server 140 may be positioned centrally in the network 150 such that the secure DNS server 140 is centralized for the whole network. Additional functionality can be provided centrally that may not be possible at the edge of the network.

A first example of an enhanced discovery protocol for mobile networks is illustrated in FIG. 2A. In this first example, the protocol is used to provision encrypted DNS (such as DoH or DoQ) for devices belonging to users having personal services enabled. In order to do so, a secure DNS server 240 must be provisioned, so that the secure DNS server 240 is able to identify the user (must have customer awareness). This is not possible in the standard DDR protocol described in relation to FIG. 1 because the secure DNS server 140 is positioned centrally in the network and cannot reliably determine the user identity based on IP address (which may have been subject to Network Address Translation, NAT). Therefore, the enhanced method enriches the standard DDR response with a field that the secure DNS server 240 can use to identify the user.

A plain DNS server 220 is provided at the edge of the network, so that network address translation is not performed between the user device 210 and the plain DNS server 220. The plain DNS server 220 can identify the user, based on the client address (which is also the user device address, since there is no network address translation). Therefore, the plain DNS server 220 has user awareness (or “customer awareness”).

At step 201, the user device 210 sends a message to the plain DNS server 220. This may be a first query to “doh. Vodafone. com”, for example.

The plain DNS server 220 uses the client address (which is also the address of the user device 210) to identify the user. The plain DNS server 220 also determines what services are enabled for the particular user. In this case, the plain DNS server 220 determines that the user has personal services enabled. Therefore, the secure DNS server 240 needs to be able to identify the user (must have customer awareness). To make this possible, the plain DNS server 220 induces the user device to send a parameter to the secure DNS server 240, which contains identifying information. In order to do so, the plain DNS server 220 may include an encrypted UserId in the SVCB fields.

At step 202, the plain DNS server 220 replies to the user device 210 and provides an address (IP address) of a secure DNS server 240. The plain DNS server 220 also provides one or more service binding, SVCB, fields to the user device 210, including an encrypted UserId.

At step 203, the user device 210 sends a message to the secure DNS server 240 at the address supplied by the plain DNS server 220. The address include a parameter that enables the secure DNS server 240 to identify the user. For example, the user device 210 may send a message to
HTTPS://<encryptedUserId>.doh.Vodafone.com/?dns
   Where, “<encryptedUserId>” is an encrypted user identifier that enables the secure DNS server 240 to determine the identity of the user. Since the user identifier is encrypted, the user identifier cannot be extracted by simply intercepting the traffic or by a “man-in-the-middle” attack.

The method outlined above provides a secure DNS bootstrap mechanism for user devices connected via a mobile network, where the user has personalised services. In this method, the port53 DNS server 220 responds to the user device 210 during the discovery phase by adding a user identifier. The flow diagram is illustrated in FIG. 2B.

A first part 270 of the flow diagram of FIG. 2B illustrates encrypted DNS service discovery. At step 271, user device 210 sends a DNS resolver message to port 53 on plain DNS server 220. For example, the user device may send the following message at step 271:
dns.resolver.arpa type SVCB

In response, the plain DNS server 220 may provide the user device 210 with the DoH address and SVCB fields. For example, the plain DNS server 220 may supply the following response at step 272:
<encryptedUserID>.doh.vodafone.com
(dohpath=/dns-query/dns=)

Due to these provisioning steps during encrypted DNS service discovery, the user device 210 is provided with an address for a secure DNS server 240 (which may be a URI), such that secure DNS requests are directed to a secure DNS server 240 that is configured to provide user-specific services. Moreover, the address of the secure DNS server 240 includes an encrypted user ID. As a result, the secure DNS server 240 is able to identify the user and determine a personalised policy for that user. In this example, the personalised policy indicates that the user is under 18. Therefore, content that is only suitable for adults should be blocked by the secure DNS server 240.

A second part 280 of the flow diagram of FIG. 2B illustrates a request for content that is not blocked by the personalized policy for the user. At step 281, the user device 210 sends a message to secure DNS server 240, which is configured to provide personalised services. The message includes a parameter that enables the secure DNS server 240 to identify the user. For example, an encrypted userID may be provided as part of the domain in the address to which the user device 210 sends the message (e.g., a subdomain). Alternatively, an encrypted user ID may be included as a subdirectory or as a query parameter. The message includes the domain name that the user device 210 intends to resolve, for example:
www.wikipedia.com type A or AAAA

The secure DNS server 240 identifies the user and determines whether the personalised policy allows the user to resolve the requested domain. In this case, the content is not blocked. Therefore, at step 282 the secure DNS server 240 sends the IP address of a content server 230 hosting the requested domain:
xx.xx.xx.xx

At step 283, the user device 210 requests content from the content server 230:
HTTPS GET www.wikipedia.com

A third part 290 of the flow diagram of FIG. 2B illustrates a request for content that is blocked by the personalized policy for the user. At step 291, the user device 210 sends a message to secure DNS server 240. As before, the message includes a parameter that enables the secure DNS server 240 to identify the user. The message includes the domain name that the user device 210 intends to resolve. In this example, the domain relates to a website hosting content that is not suitable for users under the age of 18. For example:
www.adultsite.com type A or AAAA

The secure DNS server 240 identifies the user and determines whether the personalised policy allows the user to resolve the requested domain. In this case, the user is under 18 and the content is blocked. Therefore, at step 282 the secure DNS server 240 sends an error message, rather than resolving the domain:
NXDOMAIN with Extended DNS Error Code 18—
“why we blocked the content”

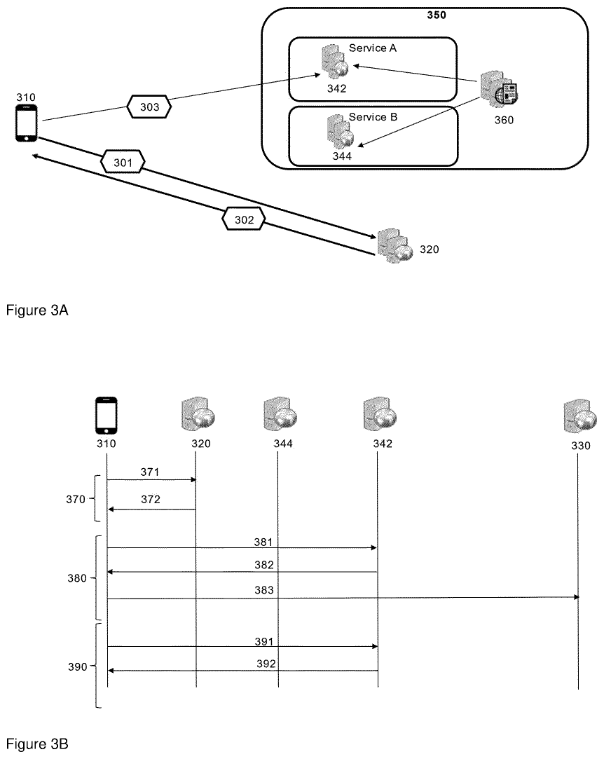

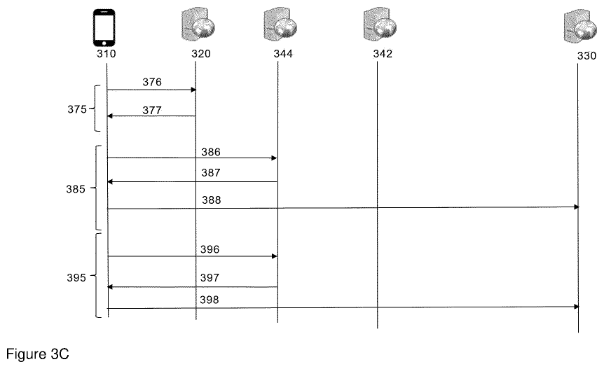

A second example of an enhanced discovery protocol for mobile networks is illustrated in FIG. 3A. In this second example, the protocol is used to provision a secure DNS server 342, 344 (such as a DoH server or DoQ server) for users who are grouped by services. In other words, users that require the same services are grouped together and a secure DNS server 342, 344 that is configured to provide those services is provisioned for the users. In this case, it is not essential for the secure DNS server 342, 344 to identify the user, because each user provisioned to the secure DNS server 342, 344 requires the same services. The plain DNS server 320 nevertheless needs to be able to identify the user, so that the correct secure DNS server 342, 344 may be provisioned to the user device, based on the services required by the user. In the standard DDR protocol described in relation to FIG. 1, only one secure DNS server 140 is provided. Moreover, the secure DNS server 140 in the standard DDR protocol is not customer aware. Therefore, there is no way to provide different service levels to different groups of users. In contrast, the enhanced method in the second example enriches the standard DDR response by provisioning a different secure DNS server 342, 344, based on the identity of the user (and/or the services required by the user).

A plain DNS server 320 is provided at the edge of the network, so that network address translation is not performed between the user device 310 and the plain DNS server 320. The plain DNS server 320 can identify the user, based on the client address. Since there is no network address translation, the client address is the address of the user device 310. Therefore, since the plain DNS server 320 can identify the user, the plain DNS server 320 has customer awareness.

At step 301, the user device 310 sends a message to the plain DNS server 320. This may be a first query to “doh.Vodafone.com”, for example.

The plain DNS server 320 uses the client address to identify the user (this may be the IP address of the user device 310). The plain DNS server 320 also determines what services are enabled for the particular user. In this case, the plain DNS 320 server determines that the user has a predetermined selection of services enabled, which are referred to as “Service A” in this example. The plain DNS server 320 therefore provisions a secure DNS server 342 to the user device 310, where the secure DNS server 342 is configured to provide the required services. In order to do so, the plain DNS server 320 may include an indication of the required service profile in the SVCB fields.

At step 302, the plain DNS server 320 replies to the user device 310 and provides an address (e.g. IP address or URI) of a secure DNS server 342. The plain DNS server 320 also provides one or more service binding, SVCB, fields to the user device 310, including the required service profile.

At step 303, the user device 310 sends a message to the secure DNS server 342 at the address supplied by the plain DNS server 320. The address may include a parameter that to identify the secure DNS server 342 configured to provide the required service profile (e.g., as a subdomain). For example, the user device 310 may send a message to
HTTPS://serviceA.doh.Vodafone.com/?dns
   where, “serviceA” identifies the secure DNS server configured to provide the required services.

The method outlined above provides a secure DNS bootstrap mechanism for a user device connected via a mobile network, where the user does not have personalised services, but rather is placed in a group with other users having a common service profile. In this method, the port53 DNS server 320 responds to the user device 310 during the discovery phase by adding a service profile identifier or secure DNS server identifier.

FIG. 3B illustrates a flow diagram for a user allocated to a first service profile, where the first service profile defines services for users who are under 18.

A first part 370 of the flow diagram of FIG. 3B illustrates DoH service discovery. At step 371, user device 310 sends a DNS resolver message to port 53 on plain DNS server 320. For example, the user device 310 may send the following message at step 371:
dns.resolver.arpa type SVCB

In response, the plain DNS server 320 may provide the user device 310 with the DoH address and SVCB fields. For example, the plain DNS server 320 may supply the following response to the user device 310 at step 372:
Under18.doh.vodafone.com
(dohpath=/dns-query/dns=)

Due to these provisioning steps during encrypted DNS service discovery, the user device 310 is provided with an address for a secure DNS server 342 that is configured to provide services suitable for users belonging to a particular group. As a result, the secure DNS server 342 applies the correct group policy for that user. In this example, the group policy is set up for users who are under 18. Therefore, content that is only suitable for adults should be blocked by the secure DNS server 342.

A second part 380 of the flow diagram of FIG. 3B illustrates a request for content that is not blocked by the group policy. At step 381, the user device 310 sends a message to secure DNS server 342, which is configured to provide the group services. The message includes the domain name that the user device 310 intends to resolve, for example:
www.wikipedia.com type A or AAAA

The secure DNS server 342 determines whether the group policy allows the user to resolve the requested domain. In this case, the content is not blocked. Therefore, at step 382 the secure DNS server 342 sends the IP address of a content server 330 hosting the requested domain:
xx.xx.xx.xx

At step 383, the user device 310 requests content from the content server 330:
HTTPS GET www.wikipedia.com

A third part 390 of the flow diagram of FIG. 3B illustrates a request for content that is blocked by the group policy for the user. At step 391, the user device 310 sends a message to secure DNS server 342. The message includes the domain name that the user device 310 intends to resolve. In this example, the domain relates to a website hosting content that is not suitable for users under the age of 18. For example:
www.adultsite.com type A or AAAA

The secure DNS server 342 determines whether the personalised policy allows the user to resolve the requested domain. In this case, the user is under 18 and the content is blocked. Therefore, at step 382 the secure DNS server 342 sends an error message, rather than resolving the domain:
NXDOMAIN with Extended DNS Error Code 18—
“why we blocked the content”

FIG. 3C illustrates a flow diagram for a user allocated to a second service profile, where the second service profile defines services for users who are over 18.

A first part 375 of the flow diagram of FIG. 3C illustrates DoH service discovery. At step 376, user device 310 sends a DNS resolver message to port 53 on plain DNS server 320. For example, the user device 310 may send the following message at step 376:
dns.resolver.arpa type SVCB

In response, the plain DNS server 320 may provide the user device 310 with the address of the secure DNS server 344 and SVCB fields. The SVCB fields may indicate that the user is allocated service profile “ServiceB”, which is implemented by a secure DNS server 344 that is different to the secure DNS server 342 implementing the first service profile “ServiceA”. For example, the plain DNS server 320 may supply the following response to the user device 310 at step 377:
Over18.doh.vodafone.com
(dohpath=/dns-query/dns=)

Due to these provisioning steps during encrypted DNS service discovery, the user device 310 is provided with an address of a secure DNS server 344 that is configured to provide preconfigured services suitable for users belonging to a particular group. As a result, the secure DNS server 344 applies the correct group policy for that user. In this example, the group policy is set up for users who are over 18. Therefore, content that is only suitable for adults should not be blocked by the secure DNS server 344.

A second part 385 of the flow diagram of FIG. 3B illustrates a request for content that is not blocked by the group policy. At step 386, the user device 310 sends a message to secure DNS server 344, which is configured to provide the group services for the second group. As before, the message includes the domain name that the user device 310 intends to resolve, for example:
www.wikipedia.com type A or AAAA

The secure DNS server 344 determines whether the group policy allows the user to resolve the requested domain. In this case, the content is not blocked. Therefore, at step 387 the secure DNS server 344 sends the IP address of a content server 330 hosting the requested domain:
xx.xx.xx.xx

At step 388, the user device 310 requests content from the content server 330:
HTTPS GET www.wikipedia.com

A third part 395 of the flow diagram of FIG. 3B illustrates a request for content that is blocked by the group policy for the user. At step 396, the user device 310 sends a message to secure DNS server 344. The message includes the domain name that the user device 310 intends to resolve. In this example, the domain relates to a website hosting content that is not suitable for users under the age of 18. For example:
www.adultsite.com type A or AAAA

The secure DNS server 344 determines whether the group policy allows the user to resolve the requested domain. In this case, the user is over 18 and the content is not blocked. Therefore, at step 397 the secure DNS server 344 sends the IP address of a content server 330 hosting the requested domain:
yy.yy.yy.yy

At step 398, the user device 310 requests content from the content server 330:
HTTPS GET www.adultsite.com

In the examples described above with reference to FIGS. 2A, 2B, 3A, 3B and 3C, the plain DNS server 220, 320 provisions the secure DNS server 240, 342, 344 for the user device, based on the services required by the user. In the example described in relation to FIGS. 2A and 2B, secure DNS server 240 is provided for users with personal services. In the examples described in relation to FIGS. 3A, 3B and 3C, secure DNS server 342 is provided for a group of users having a particular service profile “service A”, whereas secure DNS server 344 is provided for a group of users having a different service profile “service B”.

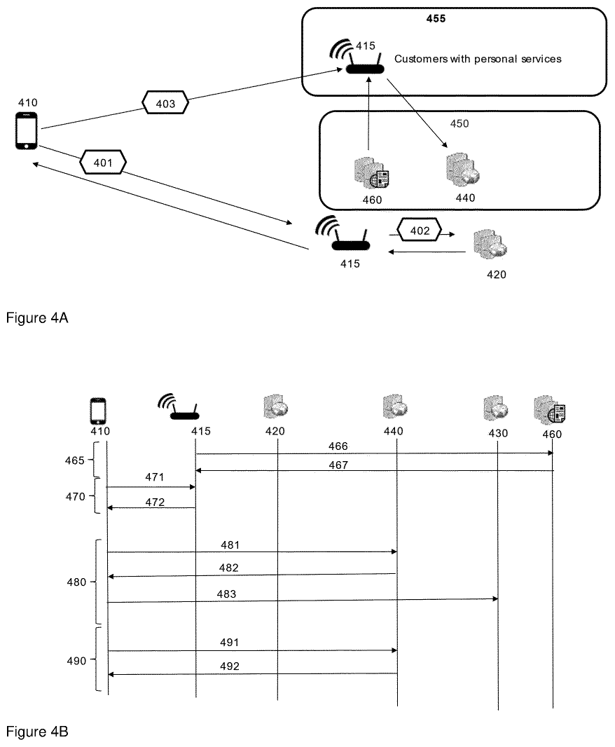

The scenario for user devices connected via a fixed network is more complex than for user devices connected via a mobile network. A third example of an enhanced discovery protocol for fixed networks is illustrated in FIG. 4A. In this third example, the protocol is used to provision DoH for users having personal services and configured to access the internet via a customer premises equipment, CPE 415 (e.g., a home router). In order to provide personalised services, the DoH must be able to identify the user. This is not possible in the standard DDR protocol described in relation to FIG. 1 because the secure DNS server 140 is positioned centrally in the network and cannot reliably determine the user identity based on IP address (which may have been subject to Network Address Translation, NAT). Therefore, the enhanced method enriches the standard DDR response with a field that the DoH can use to identify the user.

As illustrated in FIG. 4A, user device 410 is configured to access the internet via CPE 415. A plain DNS server 420 is provided at the edge of the network, so that network address translation is not performed between the CPE 415 and the plain DNS server 420. Unlike the mobile data connection example illustrated in FIG. 2A, the client address is not sufficient for the plain DNS server 420 to identify the user. This is because the client address is the address of the CPE 415, rather than the address of the user device 410. Multiple different user devices may be connected to the internet via the CPE 415. Therefore, in order to uniquely identify the user device 410, the plain DNS server 420 requires the address of the CPE (the client address) and an identifier of the user device 310 (e.g., a MAC address). Using the combination of these two identifiers, the DNS server 420 can identify the user. Therefore, the plain DNS server 420 has customer awareness.

At step 401, the user device 410 sends a message to the CPE DNS resolver 415. This may be a first query to “doh.Vodafone.com”, for example.

At step 402, the CPE DNS resolver 415 send a message to a plain DNS server 420.

The plain DNS server 420 uses the IP address of the CPE and the MAC address of the user device 410 to identify the user. The plain DNS server 420 also determines what services are enabled for the particular user. In this case, the plain DNS server 420 determines that the user has personal services enabled. Therefore, the plain DoH server 420 needs to be able to identify the user. Therefore, the plain DNS server 420 induces the user device 410 to send a parameter to the secure DNS server 440, which contains identifying information. In order to do so, the plain DNS server 420 may include an encrypted UserId and MAC address in the SVCB fields.

The plain DNS server 420 replies to the user device 410 and provides an address (IP address, domain and/or URI) of a secure DNS server 440 (such as a DoH or DoQ server). The plain DNS server 420 also provides one or more service binding, SVCB, fields to the user device 410, including an encrypted UserId and MAC address. The additional field in the DDR response allows the secure DNS server 440 to identify the user (using a combination of the CPE+MAC address).

The plain DNS server 420 also determines that the user is connected via a fixed line connection and CPE. Therefore, the plain DNS server 420 provisions a secure DNS server 440 configured for use via a CPE. In order for the CPE 415 to operate as part of the encrypted DNS arrangement, it must be provisioned with a certificate, which is specific for each CPE. The certificate may be generated by a certificate server 460 and sent to the CPE 415. This allows the DNS resolver on the CPE 415 to decode the secure DNS traffic and correctly route requests to the DoH server 440.

In this scenario the port53 DNS 420 is aware of the CPE 415 and responds to the discovery request by creating a DoH URI comprising the user identifier and the CPE DoH resolver domain. For example:
<UserIdentifier>.<CPEidentifier>.vodafone.com

During the first connection, the certificate server 460 generates a new certificate for the domain:
*.CPEidentifier.vodafone.com
   and injects the certificate into the CPE.

At step 403, the client 410 sends a message to the DNS responder on the CPE 415, within the user's home network 455. The DNS responder on the CPE 415 is able to communicate securely with the secure DNS server 440 at the address supplied by the plain DNS server 220, using the certificate supplied by the certificate server 460. The address of the secure DNS server includes a parameter that enables the secure DNS server 440 to identify the user. For example, the user device 410 may send a message to
HTTPS://<encryptedUserId+MAC>.CPEdohx.Vodafone.com/?dns
   Where, “<encryptedUserId+MAC>” is an encrypted combination of the user identifier and MAC address, which enables the secure DNS server 440 to determine the identity of the user.

The method outlined above provides a secure DNS bootstrap mechanism for a user device connected via a fixed network, where the user has personalised services. In this method, the port53 DNS server 420 responds to the user device 410 during the discovery phase by adding a CPE identifier and a user device identifier. FIG. 4B illustrates a flow diagram for a user device 410 having personal services connected to the internet via a customer premises equipment, CPE 415.

A first part 465 of the flow diagram of FIG. 4B illustrates certificate acquisition. At step 466, CPE 415 requests a certificate from certificate server 460. At step 467, certificate server 460 sends a certificate to the CPE 415. For example, the certificate server 460 may send a certificate for *.CPEidentifier.vodafone.com to the CPE 415. The certificate may only need to be sent to the CPE 415 once, during set up.

A second part 470 of the flow diagram of FIG. 4B illustrates DoH service discovery. At step 471, user device 410 sends a DNS resolver message to the CPE DNS resolver 415. For example, the user device 410 may send the following message at step 471:
dns.resolver.arpa type SVCB

In response, the plain DNS server 420 may provide the user device 410 with the address of the secure DNS server 440 and SVCB fields. For example, the plain DNS server 420 may supply the following response at step 472:
<encryptedUserId+MAC>.CPEdohx.vodafone.com
(dohpath=/dns-query/dns=)

Due to these provisioning steps during secure DNS service discovery, the user device 410 is provided with a secure DNS address that directs secure DNS requests via the CPE 415 to a secure DNS server 440 that is configured to provide user-specific services. Moreover, the secure DNS address includes an encrypted user ID and MAC address. As a result, the secure DNS server 440 is able to identify the user and determine a personalised policy for that user. In this example, the personalised policy indicates that the user is under 18. Therefore, content that is only suitable for adults should be blocked by the secure DNS server 440.

A third part 480 of the flow diagram of FIG. 4B illustrates a request for content that is not blocked by the personalized policy for the user and device. At step 481, the user device 410 sends a message to secure DNS server 440, which is configured to provide personalised services. The message includes a parameter that enables the secure DNS server 440 to identify the user. For example, an encrypted userID and MAC address may be provided as part of the address of the secure DNS server 440 (e.g., a subdomain). Alternatively, an encrypted user ID may be included as a subdirectory or as a query parameter. The message includes the domain name that the user device 410 intends to resolve, for example:
www.wikipedia.com type A or AAAA

The secure DNS server 440 identifies the user and determines whether the personalised policy allows the user to resolve the requested domain. In this case, the content is not blocked. Therefore, at step 482 the secure DNS server 440 sends the IP address of a content server 430 hosting the requested domain:
xx.xx.xx.xx

At step 483, the user device 410 requests content from the content server 430:
HTTPS GET www.wikipedia.com

A fourth part 490 of the flow diagram of FIG. 4B illustrates a request for content that is blocked by the personalized policy for the user and device. At step 491, the user device 410 sends a message to secure DNS server 440. As before, the message includes a parameter that enables the secure DNS server 440 to identify the user and device. The message includes the domain name that the user device 410 intends to resolve. In this example, the domain relates to a website hosting content that is not suitable for users under the age of 18. For example:
www.adultsite.com type A or AAAA

The secure DNS server 440 identifies the user and determines whether the personalised policy allows the user to resolve the requested domain. In this case, the user is under 18 and the content is blocked. Therefore, at step 482 the secure DNS server 440 sends an error message, rather than resolving the domain:
NXDOMAIN with Extended DNS Error Code 18—
“why we blocked the content”

As used herein, including in the claims, unless the context indicates otherwise, singular forms of the terms herein are to be construed as including the plural form and vice versa. For instance, unless the context indicates otherwise, a singular reference herein including in the claims, such as “a” or “an” means “one or more”. Throughout the description and claims of this disclosure, the words “comprise”, “including”, “having” and “contain” and variations of the words, for example “comprising” and “comprises” or similar, mean “including”, and are not intended to (and do not) exclude other components.

Although embodiments according to the disclosure have been described with reference to particular devices and protocols, and the embodiments have particular advantages in such case, as discussed herein, approaches according to the disclosure may be applied to other types of networks. The specific structural details of the platform and servers, whilst potentially advantageous (especially in view of known IP constraints and capabilities), may be varied significantly to arrive at devices and methods with similar or identical operation. Each feature disclosed in this specification, unless stated otherwise, may be replaced by alternative features serving the same, equivalent or similar purpose. Thus, unless stated otherwise, each feature disclosed is one example only of a generic series of equivalent or similar features.

The use of any and all examples, or exemplary language (“for instance”, “such as”, “for example” and like language) provided herein, is intended merely to better illustrate the invention and does not indicate a limitation on the scope of the invention unless otherwise claimed. No language in the specification should be construed as indicating any non-claimed element as essential to the practice of the invention.

Any steps described in this specification may be performed in any order or simultaneously unless stated or the context requires otherwise.

All of the aspects and/or features disclosed in this specification may be combined in any combination, except combinations where at least some of such features and/or steps are mutually exclusive. As described herein, there may be particular combinations of aspects that are of further benefit, such the aspects of determining a set of compensation parameters and applying a set of compensation parameters to measurements. In particular, the preferred features of the invention are applicable to all aspects of the invention and may be used in any combination. Likewise, features described in non-essential combinations may be used separately (not in combination).

1. A method of provisioning an encrypted Domain Name System, DNS, the method comprising:
receiving, from a user device, a message requesting an address of a secure DNS server, wherein the message comprises a client address;
determining, based on the client address, the address of the secure DNS server; and
sending, to the user device, a message comprising the address of the secure DNS server.

2. The method of claim 1, wherein the client address is an address of the user device.

3. The method of claim 2, wherein determining the address of the secure DNS server comprises:
retrieving user data associated with the user device from a data store, based on the address of the user device, and
wherein the user data comprises one or more of:
user identity;
user service profile preferences; or
user characteristics.

4. The method of claim 1, wherein determining the address of the secure DNS server further comprises:
selecting the secure DNS server from a plurality of secure DNS servers, based on a user identity, user service profile preferences, and/or user characteristics.

5. The method of claim 1, wherein the message received from the user device is received via a home router,
wherein the home router is configured to perform network address translation, NAT, and
wherein the client address is an address of the home router.

6. The method of claim 5, wherein the message received from the user device further comprises a user device identifier, and
wherein the determining is further based on the user device identifier.

7. The method of claim 6, wherein determining the address of the secure DNS server comprises retrieving user data associated with the user device from a data store, based on the address of the home router and the user device identifier, and
wherein the user data comprises one or more of:
user service profile preferences; or
user characteristics.

8. The method of claim 5, further comprising:
sending a message to a certificate server to request that the certificate server generate a certificate and send the certificate to the home router.

9. The method of claim 5, wherein determining the address of the secure DNS server further comprises:
selecting the secure DNS server from a plurality of secure DNS servers, based on user service profile preferences and/or user characteristics,
wherein the plurality of secure DNS servers comprises the home router.

10. The method of claim 1, further comprising:
determining, based on the client address, one or more DNS parameters,
wherein the message sent to the user device further comprises the one or more DNS parameters.

11. The method of claim 10, wherein the one or more DNS parameters are Service Binding, SVCB, fields.

12. The method of claim 10, wherein the one or more DNS parameters comprise a user identifier, preferably an encrypted user identifier.

13. The method of claim 1, wherein:
the message received from the user device is an internet protocol, IP, message received via IP port 53; and/or
the encrypted Domain Name System is DNS over HTTPS, DoH, or DNS over QUIC, DoQ.

14. A server configured to perform operations comprising:
receiving, from a user device, a message requesting an address of a secure DNS server, wherein the message comprises a client address;
determining, based on the client address, the address of the secure DNS server; and
sending, to the user device, a message comprising the address of the secure DNS server.

15. A non-transitory computer readable storage medium storing instructions that, when executed by a processor of a computer, cause the computer to perform operations comprising:
receiving, from a user device, a message requesting an address of a secure DNS server, wherein the message comprises a client address;
determining, based on the client address, the address of the secure DNS server; and
sending, to the user device, a message comprising the address of the secure DNS server.
